(19) United States
(12) Patent Application Publication
(10) Pub. No.: US 2024/0165561 A1
(43) Pub. Date: May 23, 2024

(54) AN AMMONIA OXIDATION CATALYST AND METHODS FOR ITS PREPARATION

(71) Applicant: BASF Corporation, Florham Park, NJ (US)

(72) Inventors: Marcus Hilgendorff, Hannover (DE); Tobias Guenter, Ludwigshafen am Rhein (DE)

(21) Appl. No.: 18/277,306

(22) PCT Filed: Feb. 16, 2022
(86) PCT No.: PCT/EP2022/053751

§ 371 Date: Aug. 15, 2023

(30) Foreign Application Priority Data
Feb. 17, 2021 (EP) 21157604.6

(51) Int. Cl. B01D 53/94; B01J 23/63; B01J 23/656; B01J 29/76; B01J 37/00; B01J 37/02; B01J 37/04; B01J 37/08; F01N 3/035; F01N 3/20; F01N 3/28

(52) U.S. Cl. CPC B01D 53/9436; B01D 53/9418; B01D 53/9477; B01J 23/63; B01J 23/6562; B01J 29/76; B01J 29/763; B01J 37/0009; B01J 37/0213; B01J 37/0236; B01J 37/0246; B01J 37/0248; B01J 37/04; B01J 37/088; F01N 3/035; F01N 3/2066; F01N 3/2828; B01D 2255/1021; B01D 2255/2066; B01D 2255/20707; B01D 2255/2073; B01D 2255/20738; B01D 2255/20761; B01D 2255/40; B01D 2255/50; B01D 2257/404; B01D 2257/406; B01D 2258/012; B01J 2229/186; F01N 2370/04; F01N 2510/063; F01N 2510/0684; F01N 2610/1453

(57) ABSTRACT

The present invention relates to a catalyst for the oxidation of ammonia (AMOX catalyst), wherein the catalyst comprises as components: (a) Pt and/or Pd as one or more platinum group metals, wherein the one or more platinum group metals are supported on a support material; (b) one or more rare earth metal oxides selected from the group of oxides of Pr, Nd, and Ce, including combinations of two or more thereof; (c) one or more transition metal oxides selected from the group consisting of oxides of Mn, Ti, V, Nb, and Ta, including combinations of two or more thereof; (d) one or more zeolitic materials; and (e) optionally one or more binders; wherein the one or more zeolitic materials are loaded with Cu and/or Fe. The present invention also relates to an exhaust gas treatment system comprising the inventive catalyst for the oxidation of ammonia, as well as to a process for the preparation of a catalyst for the oxidation of ammonia, and to the use of the inventive catalyst.

### TECHNICAL FIELD

The present invention relate to a catalyst for the oxidation of ammonia (AMOX catalyst), as well as to a process for the preparation of an AMOX catalyst. The present invention furthermore relates to a method for the selective catalytic reduction of NOx which employs an AMOX catalyst, as well as to the general use of the AMOX catalyst according to the invention.

### INTRODUCTION

Diesel engine exhaust is a heterogeneous mixture that contains particulate emissions such as soot and gaseous emissions such as carbon monoxide, unburned or partially burned hydrocarbons, and nitrogen oxides (collectively referred to as NOx). Catalyst compositions, often disposed on one or more monolithic substrates, are placed in engine exhaust systems to convert certain or all of these exhaust components to innocuous compounds. Ammonia selective catalytic reduction (SCR) is a NOx abatement technology that is used to meet strict NOx emission targets in diesel and lean-burn engines. In the ammonia SCR process, NOx (normally consisting of NO+NO₂) is reacted with ammonia (or an ammonia precursor such as urea) to form dinitrogen (N₂) over a catalyst typically composed of base metals. This technology is capable of NOx conversions greater than 90% over a typical diesel driving cycle, and thus it represents one of the best approaches for achieving aggressive NOx abatement goals.

A characteristic feature of some ammonia SCR catalyst materials is a propensity to retain considerable amounts of ammonia on Lewis and Brønsted acidic sites on the catalyst surface during low temperature portions of a typical driving cycle. A subsequent increase in exhaust temperature can cause ammonia to desorb from the ammonia SCR catalyst surface and exit the exhaust pipe of the vehicle. Overdosing ammonia in order to increase NOx conversion rate is another potential scenario where ammonia may exit from the ammonia SCR catalyst.

Ammonia slip from the ammonia SCR catalyst presents a number of problems. The odor threshold for NH₃ is 20 ppm in air. Eye and throat irritation are noticeable above 100 ppm, skin irritation occurs above 400 ppm, and the IDLH is 500 ppm in air. NH₃ is caustic, especially in its aqueous form, Condensation of NH₃ and water in cooler regions of the exhaust line downstream of the exhaust catalysts will give a corrosive mixture.

Therefore, it is desirable to eliminate the ammonia before it can pass into the tailpipe. A selective ammonia oxidation (AMOX) catalyst is employed for this purpose, with the objective to convert the excess ammonia to N₂. It would be desirable to provide a catalyst for selective ammonia oxidation that is able to convert ammonia at a wide range of temperatures where ammonia slip occurs in the vehicles driving cycle, and can produce minimal nitrogen oxide byproducts. The AMOX catalyst should also produce minimal N₂O, which is a potent greenhouse gas.

WO 2015/172000 A1 relates to an ammonia-slip catalyst having Pt impregnated on high porosity substrates. CN 109590021 A relates to a sandwich-structure ammonia oxidation catalyst as well as to a method for its preparation.

US 2012/0167553 A1, on the other hand, relates to an exhaust gas treatment system including an NH₃-SCR catalyst promoted with an oxygen storage material. Jingdi, C. et al. in Chem. J. of Chin. Univ. 2015, Vol. 36, No. 3, pages 523-530, for its part, relates to the promotional effect of Pr-doping on the NH₃-SCR activity in a V₂O₅—MoO₃/TiO₂ catalyst.

WO 2017/037006 A1 discloses an AMOX catalyst comprising a washcoat including copper or iron on a small pore molecular sieve material mixed with platinum and rhodium on a doped refractory metal oxide support.

WO 2020/234375 A1 discloses an AMOX catalyst comprising a coating disposed on a substrate, wherein the coating comprises a selective catalytic reduction component being a zeolitic material comprising one or more of copper and iron; and an oxidation catalytic component comprising platinum supported on a porous non-zeolitic oxidic support.

WO 2020/210295 A1 discloses an AMOX catalysts comprising a platinum group metal and a support comprising TiO₂ doped with 0-10% by weight of SiO₂, WO₃, ZrO₂, Y₂O₃, La₂O₃, or a mixture thereof.

With regard to AMOX catalysts, the use of a combination of Pt and Rh is known to afford a high efficacy in the conversion of ammonia to nitrogen gas with only low NOx and N₂O make, and to have a low NH₃ T50 light off temperature. However, as for Pt, Rh is an expensive component in such catalysts, such that there remains a need to afford a cost-efficient AMOX catalyst which affords comparable results in the oxidation of ammonia in exhaust gas treatment systems while maintaining acceptable NH₃ T50 light off temperatures.

### DETAILED DESCRIPTION

Thus, it was the object of the present invention to provide an improved AMOX catalyst, in particular with regard to catalytic activity and selectivity, as well as with regard to cost-effectiveness. Said object is achieved by the AMOX catalyst according to the present invention, as well as by the inventive method for the preparation of an AMOX catalyst. Thus, it has surprisingly been found that the specific combination of an oxygen storage component with one or more metal dioxides leads to an AMOX catalyst which displays an efficacy in the oxidation of ammonia which is comparable to AMOX catalysts which include Rh as a catalytic metal.

Therefore, the present invention relates to a catalyst for the oxidation of ammonia (AMOX catalyst), wherein the catalyst comprises as components:
(a) Pt and/or Pd as one or more platinum group metals, wherein the one or more platinum group metals are supported on a support material;
(b) one or more rare earth metal oxides selected from the group of oxides of Pr, Nd, and Ce, including combinations of two or more thereof, wherein preferably the one or more rare earth metal oxides comprise oxides of Pr and/or Nd, preferably oxides of Pr, wherein more preferably the one or more rare earth metal oxides consist of oxides of Pr and/or Nd, preferably oxides of Pr;
(c) one or more transition metal oxides selected from the group consisting of oxides of Mn, Ti, V, Nb, and Ta, including combinations of two or more thereof;
(d) one or more zeolitic materials; and
(e) optionally one or more binders;
wherein the one or more zeolitic materials are loaded with Cu and/or Fe, preferably with Cu. It is preferred that the one or more platinum group metals comprise Pt, preferably wherein the one or more platinum group metals consist of Pt.

It is preferred that the one or more platinum group metals Pt and/or Pd are contained in the catalyst in an amount ranging from 0.003 to 0.87 wt.-% calculated as the element and based on 100 wt.-% of the total amount of the components (a) to (e) contained in the catalyst, preferably from 0.009 to 0.58 wt.-%, more preferably from 0.014 to 0.43 wt.-%, more preferably from 0.023 to 0.29 wt.-%, more preferably from 0.029 to 0.2 wt.-%, more preferably from 0.043 to 0.15 wt. %, more preferably from 0.058 to 0.12 wt.-%, and more preferably from 0.072 to 0.1 wt.-%.

It is preferred that the one or more platinum group metals Pt and/or Pd are contained in the catalyst at a loading comprised in the range of from 0.1 to 30 g/ft³, preferably from 0.3 to 20 g/ft³, more preferably from 0.5 to 15 g/ft³, more preferably from 0.8 to 10 g/ft³, more preferably from 1 to 7 g/ft³, more preferably from 1.5 to 5 g/ft³, more preferably from 2 to 4 g/ft³, and more preferably from 2.5 to 3.5 g/ft³.

It is preferred that the support material is selected from the group consisting of alumina, silica, silica-alumina, lanthana-alumina, lanthana-silica, lanthana-silica-alumina, baria-alumina, baria-silica, and baria-silica-alumina, including mixtures of two or more thereof, preferably being alumina.

It is preferred that the support material is contained in the catalyst in an amount ranging from 1 to 30 wt.-% calculated as the element and based on 100 wt.-% of the total amount of the components (a) to (e) contained in the catalyst, preferably from 5 to 25 wt.-%, more preferably from 10 to 20 wt.-%, and more preferably from 13 to 17 wt.-%.

It is preferred that the catalyst comprises 1 wt.-% or less of Rh calculated as the element and based on 100 wt.-% of the total amount of the one or more platinum group metals Pt and/or Pd calculated as the element, preferably less than 0.1 wt.-%, more preferably less than 0.01 wt.-%, more preferably less than 0.001 wt.-%, and more preferably less than 0.0001 wt.-%.

It is preferred that the catalyst comprises 1 wt.-% or less of Pd calculated as the element and based on 100 wt.-% of the total amount of the one or more platinum group metals Pt and Pd calculated as the element, preferably less than 0.1 wt.-%, more preferably less than 0.01 wt.-%, more preferably less than 0.001 wt.-%, and more preferably less than 0.0001 wt.-%.

It is preferred that the catalyst comprises 0.25 to 1.75 wt.-% of the one or more rare earth metal oxides calculated as the element and based on 100 wt.-% of the total amount of the components (a) to (e) contained in the catalyst, preferably 0.5 to 1.5 wt.-%, more preferably 0.75 to 1.25 wt.-%, and more preferably 0.9 to 1.1 wt.-%.

It is preferred that the one or more rare earth metal oxides comprise praseodymium oxide, preferably Pr(III,IV) oxide, and more preferably Pr₆O₁₁, wherein more preferably praseodymium oxide is the rare metal oxide, preferably Pr(III,IV) oxide, and more preferably Pr₆O₁₁.

It is preferred that the catalyst comprises 1 to 3.4 wt.-% of the one or more transition metal oxides calculated as MO₂ and based on 100 wt.-% of the total amount of the components (a) to (e) contained in the catalyst, preferably 1.7 to 2.9 wt.-%, and more preferably 2.0 to 2.4 wt.-%.

It is preferred that the one or more transition metal oxides in (c) are selected from the group consisting of MnO₂, TiO₂, VO₂, V₂O₅, Nb₂O₅, and Ta₂O₅, including mixtures of two or more thereof, preferably from the group consisting of MnO₂, TiO₂, VO₂, V₂O₅, and Nb₂O₅, including mixtures of two or more thereof, more preferably from the group consisting of MnO₂, TiO₂, VO₂, and V₂O₅, including mixtures of two or more thereof, more preferably from the group consisting of MnO₂, TiO₂, and VO₂, and V₂O₅, wherein more preferably, the one or more transition metal oxides in (c) comprise MnO₂ and/or TiO₂, wherein more preferably, the one or more transition metal oxides in (c) consist of MnO₂ and/or TiO₂.

It is preferred that the one or more rare earth metal oxides and the one or more transition metal oxides are present as a mixed oxide.

It is preferred that the one or more transition metal oxides comprise MnO₂, wherein the one or more transition metal oxides consist of MnO₂.

It is preferred that the one or more transition metal oxides comprise TiO₂, wherein the one or more transition metal oxides consist of TiO₂.

It is preferred that the one or more transition metal oxides comprise MnO₂ and TiO₂, wherein the one or more transition metal oxides consist of MnO₂ and TiO₂.

It is preferred that the catalyst comprises 65 to 95 wt.-% of the one or more zeolitic materials based on 100 wt.-% of the total amount of the components (a) to (e) contained in the catalyst, preferably 70 to 90 wt.-%, more preferably 75 to 85 wt.-%, and more preferably 78 to 82 wt.-%.

It is preferred that the one or more zeolitic materials have a framework-type structure selected from the group consisting of CHA, AEI, RTH, LEV, DDR, KFI, ERI, and AFX, including combinations or mixed structures of two or more thereof, preferably CHA, RTH and AEI, more preferably CHA and/or AEI, and more preferably CHA.

In the case where the one or more zeolitic materials have a CHA-type framework structure, it is preferred that the one or more zeolitic materials preferably comprise one or more zeolites selected from the group consisting of of ZK-14, chabazite, Linde R, Phi, SAPO-34, willhendersonite, SSZ-13, ZYT-6, MeAPO-47, CoAPO-44, MeAPSO-47, SAPO-47, AIPO-34, GaPO-34, Linde D, [Si—O]-CHA, DAF-5, UiO-21, [Zn—As—O]-CHA, [Al—As—O]-CHA, |Co| [Be—P—O]-CHA, (Ni(deta)2)-UT-6, and SSZ-62, more preferably from the group consisting of ZK-14, chabazite, Linde R, Phi, willhendersonite, SSZ-13, ZYT-6, Linde D, [Si—O]-CHA, DAF-5, UiO-21, and SSZ62, more preferably from the group consisting of chabazite, SSZ-13, and SSZ-62, wherein more preferably the zeolitic material comprises chabazite and/or SSZ-13, preferably SSZ-13, and wherein more preferably the zeolitic material consists of chabazite and/or SSZ-13, preferably of SSZ-13.

It is preferred that the one or more zeolitic materials are loaded with the one or more transition metals in an amount ranging from 1 to 8 wt.-% of the one or more transition metals calculated as the element and based on 100 wt.-% of the one or more zeolitic materials, preferably from 2 to 6 wt.-%, more preferably from 3 to 5 wt.-%, and more preferably from 4 to 4.8 wt.-%.

It is preferred that the one or more zeolitic materials comprise SiO₂ and X₂O₃ in their framework structure, wherein X stands for one or more tetravalent elements.

In the case where the one or more zeolitic materials comprise SiO₂ and X₂O₃ in their framework structure, wherein X stands for one or more tetravalent elements, it is preferred that the one or more tetravalent elements X are selected from the group consisting of Al, B, Ga, and In, including combinations of two or more thereof, preferably from the group consisting of Al, B, and Ga, including combinations of two or more thereof, wherein more preferably X stands for Al and/or B, preferably for Al.

In the case where the one or more zeolitic materials comprise SiO₂ and X₂O₃ in their framework structure, wherein X stands for one or more tetravalent elements, it is preferred that the SiO₂:X₂O₃ molar ratio of the one or more zeolitic materials is comprised in the range of from 1 to 200, preferably from 5 to 100, more preferably from 10 to 50, more preferably from 15 to 40, more preferably from 20 to 30, more preferably from 23 to 25, and more preferably from 23.5 to 24.

In the case where the one or more zeolitic materials comprise SiO₂ and X₂O₃ in their framework structure, wherein X stands for one or more tetravalent elements, and the one or more tetravalent elements X are selected from the group consisting of Al, B, Ga, and In, including combinations of two or more thereof, it is preferred that the SiO₂:X₂O₃ molar ratio of the one or more zeolitic materials is comprised in the range of from 1 to 200, preferably from 5 to 100, more preferably from 10 to 50, more preferably from 15 to 40, more preferably from 20 to 30, more preferably from 23 to 25, and more preferably from 23.5 to 24.

It is preferred that the one or more optional binders are contained in the catalyst in an amount ranging from 1 to 7 wt.-% based on 100 wt.-% of the total amount of the components (a) to (e) contained in the catalyst, preferably from 2 to 6 wt.-%, more preferably from 3 to 5 wt.-%, and more preferably from 3.5 to 4.5 wt.-%.

It is preferred that the one or more binders are selected from the group consisting of ZrO₂, Al₂O₃, and SiO₂, wherein preferably, the one or more binders comprise ZrO₂, wherein more preferably, the one or more binders consist of ZrO₂.

It is preferred that the catalyst further comprises a substrate, wherein the substrate is preferably a monolith substrate, and more preferably a honeycomb substrate.

In case where the catalyst further comprises a substrate, it is preferred that the substrate is a wall-flow substrate or a flow-through substrate, preferably a flow-through substrate.

In case where the catalyst further comprises a substrate, it is preferred that the substrate is a metal substrate or a ceramic substrate, preferably a ceramic substrate, wherein more preferably, the substrate is a cordierite substrate.

In case where the substrate is a wall-flow substrate or a flow-through substrate it is preferred that the substrate is a metal substrate or a ceramic substrate, preferably a ceramic substrate, wherein more preferably, the substrate is a cordierite substrate.

It is preferred that the components (a) to (e) are provided as one or more washcoat layers on the substrate, wherein preferably the components (a) to (e) are comprised in the same washcoat layer, wherein more preferably the substrate is coated with a single washcoat layer comprising the components (a) to (e), wherein more preferably the substrate is coated with a single washcoat layer consisting of the components (a) to (e).

The present invention also relates to an exhaust gas treatment system for the treatment of exhaust gas exiting from an internal combustion engine, preferably from a lean burn internal combustion engine, and more preferably from a lean burn gasoline engine or from a diesel engine, the system comprising an AMOX catalyst according to any of the particular and preferred embodiments of the present invention and one or more of a diesel oxidation catalyst, a catalyst for the selective catalytic reduction of NOₓ (SCR catalyst), and an optionally catalyzed soot filter.

It is preferred that the system comprises a diesel oxidation catalyst, an optionally catalyzed soot filter and an SCR catalyst, wherein the diesel oxidation catalyst is positioned upstream of the optionally catalyzed soot filter, wherein the optionally catalyzed soot filter is positioned upstream of the SCR catalyst, and wherein the AMOX catalyst is positioned downstream of the SCR catalyst, wherein the diesel oxidation catalyst preferably is the first catalyst of the system and preferably no catalyst is present between the engine and the diesel oxidation catalyst.

It is preferred that the system further comprises a reductant injector, the reductant injector being positioned downstream of the optionally catalyzed soot filter and upstream of the SCR catalyst, wherein the reductant preferably is urea.

In case where the system further comprises a reductant injector, the reductant injector being positioned downstream of the optionally catalyzed soot filter and upstream of the SCR catalyst, wherein the reductant preferably is urea, it is preferred that the system comprises a diesel oxidation catalyst, an optionally catalyzed soot filter and an SCR catalyst, wherein the diesel oxidation catalyst is positioned upstream of the SCR catalyst and wherein the SCR catalyst is positioned upstream of the AMOX catalyst, and wherein the AMOX catalyst is positioned upstream of the optionally catalyzed soot filter, wherein the diesel oxidation catalyst preferably is the first catalyst of the system and preferably no catalyst is present between the engine and the diesel oxidation catalyst.

In case where the system comprises a diesel oxidation catalyst, an optionally catalyzed soot filter and an SCR catalyst, wherein the diesel oxidation catalyst is positioned upstream of the SCR catalyst and wherein the SCR catalyst is positioned upstream of the AMOX catalyst, and wherein the AMOX catalyst is positioned upstream of the optionally catalyzed soot filter, it is preferred that the system further comprises a reductant injector, the reductant injector being positioned downstream of the diesel oxidation catalyst and upstream of the SCR catalyst, wherein the reductant preferably is urea.

It is preferred that the system comprises an SCR catalyst and an optionally catalyzed soot filter, wherein the SCR catalyst is positioned upstream of the AMOX catalyst, and the AMOX catalyst is positioned upstream of the optionally catalyzed soot filter, wherein the SCR catalyst preferably is the first catalyst of the system and preferably no catalyst is present between the engine and the catalyst for the selective catalytic reduction of nitrogen oxide.

In case where the system comprises an SCR catalyst and an optionally catalyzed soot filter, wherein the SCR catalyst is positioned upstream of the AMOX catalyst, and the AMOX catalyst is positioned upstream of the optionally catalyzed soot filter, is preferred that the system further comprises a first reductant injector, the first reductant injector being positioned upstream of the SCR catalyst, wherein the reductant preferably is urea.

The present invention also relates to a method for the selective catalytic reduction of NOₓ, wherein the NOₓ is comprised in an exhaust gas stream, said method comprising
(A) providing the exhaust gas stream, preferably from an internal combustion engine, more preferably from a lean burn internal combustion engine, and more preferably from a lean burn gasoline engine or from a diesel engine;
(B) passing the exhaust gas stream provided in (A) through an AMOX catalyst according to any of the particular and preferred embodiments of the present invention or through an exhaust gas treatment system according to any of the particular and preferred embodiments of the present invention.

The present invention also relates to a process for the preparation of a catalyst for the oxidation of ammonia, preferably of a catalyst for the oxidation of ammonia according to any one of the particular and preferred embodiments of the present invention, wherein the process comprises:
(1) providing one or more salts of Pt and/or Pd;
(2) providing one or more support materials;
(3) impregnating the one or more salts of Pt and/or Pd provided in (1) onto the one or more support materials provided in (2);
(4) providing one or more transition metal oxides, and/or one or more precursors thereof, wherein the one or more transition metal oxides are selected from the group consisting of oxides of Mn, Ti, V, Nb, and Ta, including combinations of two or more thereof;
(5) adding the one or more transition metal oxides and/or the one or more precursors thereof provided in (4) to the one or more impregnated support materials obtained in (3) and admixing the resulting mixture;
(6) providing one or more rare earth metal oxides, and/or one or more precursors thereof, selected from the group of oxides of Pr, Nd, and Ce, including combinations of two or more thereof;
(7) adding the one or more rare earth metal oxides and/or the one or more precursors thereof provided in (6) to the mixture obtained in (5) and admixing the resulting mixture; (8) optionally drying the mixture obtained in (7);
(9) calcining the mixture obtained in (7) or (8);
(10) suspending the calcined mixture obtained in (9) in a solvent system;
(11) optionally milling the suspension obtained in (10);
(12) providing one or more zeolitic materials;
(13) optionally providing one or more binders and/or one or more precursors thereof;
(14) adding the optional one or more binders and/or the one or more precursors thereof provided in (13) to the one or more zeolitic materials provided in (12) and admixing the resulting mixture;
(15) adding the suspension obtained in (10) or (11) to the mixture obtained in (14) and admixing the resulting mixture for obtaining a slurry;
(16) providing a substrate;
(17) coating the slurry obtained in (15) onto the substrate provided in (16) for obtaining a coated substrate;
(18) optionally drying the coated substrate obtained in (17); and
(19) calcining the mixture obtained in (17) or (18);
wherein the one or more zeolitic materials provided in (12) are loaded with Cu and/or Fe, preferably with Cu.

It is preferred that in (2) the one or more support materials display a BET surface area in the range of from 80 to 220 m²/g, wherein preferably the BET surface area is determined according to ISO 9277:2010, preferably from 100 to 200 m²/g, more preferably from 130 to 170 m²/g, and more preferably from 145 to 155 m²/g.

It is preferred that in (4) the one or more transition metal oxides are selected from the group consisting of MnO₂, TiO₂, VO₂, V₂O₅, Nb₂O₅, and Ta₂O₅, including mixtures of two or more thereof, preferably from the group consisting of MnO₂, TiO₂, VO₂, V₂O₅, and Nb₂O₅, including mixtures of two or more thereof, more preferably from the group consisting of MnO₂, TiO₂, VO₂, and V₂O₅, including mixtures of two or more thereof, and more preferably from the group consisting of MnO₂, TiO₂, and VO₂, and V₂O₅, wherein more preferably, the one or more transition metal oxides comprise MnO₂ and/or TiO₂, wherein more preferably, the one or more transition metal oxides consist of MnO₂ and/or TiO₂.

It is preferred that in (4) the one or more transition metal oxides comprise TiO₂, and wherein TiO₂ is preferably provided as a hydrogel.

It is preferred that in (4) the one or more transition metal oxides comprise MnO₂, wherein preferably one or more precursors of MnO₂ are provided in (4), wherein more preferably the one or more precursors of MnO₂ comprise one or more salts of Mn(II), wherein more preferably the one or more precursors of MnO₂ comprise manganese nitrate, wherein more preferably manganese nitrate is provided in (4) as the one or more precursors of MnO₂.

It is preferred that in (4) the one or more transition metal oxides comprise TiO₂ and MnO₂, wherein preferably one or more precursors of MnO₂ are provided in (4).

It is preferred that in (5) the one or more transition metal oxides are successively added and admixed to the one or more impregnated support materials.

It is preferred that in (6) the one or more rare earth metal oxides comprise oxides of Pr and/or Nd, preferably oxides of Pr, wherein more preferably in (6) the one or more rare earth metal oxides consist of oxides of Pr and/or Nd, preferably oxides of Pr.

It is preferred that in (6) the one or more rare earth metal oxides comprise praseodymium oxide, wherein preferably one or more precursors of praseodymium oxide are provided in (6), wherein more preferably the one or more precursors of praseodymium oxide comprise one or more salts of Pr(III), wherein more preferably the one or more precursors of praseodymium oxide comprise praseodymium nitrate, wherein more preferably praseodymium nitrate is provided in (6) as the one or more precursors of praseodymium oxide.

It is preferred that in (8) drying is conducted at a temperature comprised in the range of from 40 to 200° C., preferably from 50 to 190° C., more preferably from 60 to 180° C., more preferably from 70 to 170° C., more preferably from 80 to 160° C., more preferably from 90 to 150° C., more preferably from 100 to 140° C., more preferably from 110 to 130° C., more preferably from 115 to 125° C., and more preferably from 118 to 122° C.

It is preferred that in (8) drying is conducted for a duration in the range of from 40 to 200 minutes, preferably from 60 to 180 minutes, more preferably from 70 to 170 minutes, more preferably from 80 to 160 minutes, more preferably from 90 to 150 minutes, more preferably from 100 to 140 minutes, and more preferably from 110 to 130 minutes, and more preferably from 115 to 125 minutes.

It is preferred that in (9) calcination is conducted at a temperature comprised in the range of from 200 to 1000° C., preferably from 300 to 900° C., more preferably from 350 to 850° C., more preferably from 400 to 800° C., more preferably from 450 to 750° C., more preferably from 500 to 700° C., more preferably from 565 to 625° C., and more preferably 580 to 600° C.

It is preferred that in (9) calcination is conducted for a duration in the range of from 40 to 200 minutes, preferably from 60 to 180 minutes, more preferably from 70 to 170 minutes, more preferably from 80 to 160 minutes, more preferably from 90 to 150 minutes, more preferably from 100 to 140 minutes, and more preferably from 110 to 130 minutes, and more preferably from 115 to 125 minutes.

It is preferred that in (10) the solvent system comprises destilled water, wherein distilled water is used as the solvent system in (10).

It is preferred that in (11) the suspension obtained in (10) is milled to a particle size Dv90 comprised in the range of from 1 to 30 μm, wherein preferably the particle size Dv90 is determined according to ISO 13320:2020, preferably from 5 to 25 μm, more preferably from 10 to 20 μm, and more preferably from 13 to 17 μm.

It is preferred that in (12) the one or more zeolitic materials have a framework-type structure selected from the group consisting of CHA, AEI, RTH, LEV, DDR, KFI, ERI, and AFX, including combinations or mixed structures of two or more thereof, preferably from the group consisting of CHA, RTH, and AEI, including combinations or mixed structures of two or more thereof, wherein more preferably in (12) the one or more zeolitic materials have a CHA and/or AEI framework-type structure, and more preferably a CHA framework-type structure.

In case where in (12) the one or more zeolitic materials have a CHA-type framework structure, It is preferred that the one or more zeolitic materials comprise one or more zeolites selected from the group consisting of ZK-14, chabazite, Linde R, Phi, SAPO-34, willhendersonite, SSZ-13, ZYT-6, MeAPO-47, CoAPO-44, MeAPSO-47, SAPO-47, AIPO-34, GaPO-34, Linde D, [Si—O]-CHA, DAF-5, UiO-21, [Zn—As—O]-CHA, [Al—As—O]-CHA, |Co| [Be—P—O]-CHA, (Ni(deta)2)-UT-6, and SSZ-62, more preferably from the group consisting of ZK-14, chabazite, Linde R, Phi, willhendersonite, SSZ-13, ZYT-6, Linde D, [Si—O]-CHA, DAF-5, UiO-21, and SSZ-62, more preferably from the group consisting of chabazite, SSZ-13, and SSZ-62, wherein more preferably the zeolitic material comprises chabazite and/or SSZ-13, preferably SSZ-13, and wherein more preferably the zeolitic material consists of chabazite and/or SSZ-13, preferably of SSZ-13.

It is preferred that in (12) the one or more zeolitic materials are loaded with the one or more transition metals in an amount ranging from 1 to 8 wt.-% of the one or more transition metals calculated as the element and based on 100 wt.-% of the one or more zeolitic materials, preferably from 2 to 6 wt.-%, more preferably from 3 to 5 wt.-%, and more preferably from 4 to 4.8 wt. %.

It is preferred that in (12) the one or more zeolitic materials comprise SiO₂ and X₂O₃ in their framework structure, wherein X stands for one or more tetravalent elements.

In case where in (12) the one or more zeolitic materials comprise SiO₂ and X₂O₃ in their framework structure, wherein X stands for one or more tetravalent elements, it is preferred that in (12) the one or more tetravalent elements X are selected from the group consisting of Al, B, Ga, and In, including combinations of two or more thereof, preferably from the group consisting of Al, B, and Ga, including combinations of two or more thereof, wherein more preferably X stands for Al and/or B, preferably for Al.

In case where in (12) the one or more zeolitic materials comprise SiO₂ and X₂O₃ in their framework structure, wherein X stands for one or more tetravalent elements, it is preferred that in (12) the SiO₂:X₂O₃ molar ratio of the one or more zeolitic materials is comprised in the range of from 1 to 200, preferably from 5 to 100, more preferably from 10 to 50, more preferably from 15 to 40, more preferably from 20 to 30, more preferably from 23 to 25, and more preferably from 23.5 to 24.

In case where in (12) the one or more zeolitic materials comprise SiO₂ and X₂O₃ in their framework structure, wherein X stands for one or more tetravalent elements, the one or more tetravalent elements X are selected from the group consisting of Al, B, Ga, and In, including combinations of two or more thereof, it is preferred that in in (12) the SiO₂:X₂O₃ molar ratio of the one or more zeolitic materials is comprised in the range of from 1 to 200, preferably from 5 to 100, more preferably from 10 to 50, more preferably from 15 to 40, more preferably from 20 to 30, more preferably from 23 to 25, and more preferably from 23.5 to 24.

It is preferred that in (12) the one or more zeolitic materials display a particle size Dv90 comprised in the range of from 1 to 10 μm, wherein preferably the particle size Dv90 is determined according to ISO 13320:2020, preferably from 3 to 8 μm, more preferably from 6 to 7, and more preferably from 6.5 to 5.5 μm

It is preferred that in (13) the one or more binders are selected from the group consisting of ZrO₂, Al₂O₃, and SiO₂, wherein preferably, the one or more binders comprise ZrO₂, wherein more preferably, the one or more binders consist of ZrO₂.

It is preferred that in (13) the one or more binders comprise ZrO₂, wherein preferably one or more precursors of ZrO₂ are provided in (13), wherein more preferably the one or more precursors of ZrO₂ comprise one or more salts of Zr(IV), wherein more preferably the one or more precursors of ZrO₂ comprise zirconium acetate, wherein more preferably zirconium acetate is provided in (13) as the one or more precursors of ZrO₂.

It is preferred that admixing in (14) is conducted for a period comprised in the range of from 4 to 20 hours, preferably from 6 to 18 hours, more preferably from 8 to 16 hours, more preferably from 10 to 14 hours, and more preferably from 11 to 13 hours.

It is preferred that in (16) the substrate is a monolith substrate, and is preferably a honeycomb substrate.

In case where in (16) the substrate is a monolith substrate, it is preferred that the substrate is a wall-flow substrate or a flow-through substrate, preferably a flow-through substrate.

In case where in in (16) the substrate is a monolith substrate, it is preferred that the substrate is a metal substrate or a ceramic substrate, preferably a ceramic substrate, wherein more preferably, the substrate is a cordierite substrate.

In case where in (16) the substrate is a wall-flow substrate or a flow-through substrate, it is preferred that the substrate is a metal substrate or a ceramic substrate, preferably a ceramic substrate, wherein more preferably, the substrate is a cordierite substrate.

It is preferred that in (8) drying is conducted at a temperature comprised in the range of from 40 to 200° C., preferably from 50 to 190° C., more preferably from 60 to 180° C., more preferably from 70 to 170° C., more preferably from 80 to 160° C., more preferably from 90 to 150° C., more preferably from 100 to 140° C., more preferably from 110 to 130° C., more preferably from 115 to 125° C., and more preferably from 118 to 122° C.

It is preferred that in (8) drying is conducted for a duration in the range of from 40 to 200 minutes, preferably from 60 to 180 minutes, more preferably from 70 to 170 minutes, more preferably from 80 to 160 minutes, more preferably from 90 to 150 minutes, more preferably from 100 to 140 minutes, and more preferably from 110 to 130 minutes, and more preferably from 115 to 125 minutes.

It is preferred that in (9) calcination is conducted at a temperature comprised in the range of from 300 to 900° C., preferably from 350 to 850° C., more preferably from 400 to 800° C., more preferably from 450 to 750° C., more preferably from 500 to 700° C., more preferably from 550 to 650° C., more preferably from 590 to 610° C., and more preferably from 598 to 602° C.

It is preferred that in (9) calcination is conducted for a duration in the range of from 40 to 200 minutes, preferably from 60 to 180 minutes, more preferably from 70 to 170 minutes, more preferably from 80 to 160 minutes, more preferably from 90 to 150 minutes, more preferably from 100 to 140 minutes, and more preferably from 110 to 130 minutes, and more preferably from 115 to 125 minutes.

The present invention further relates to a catalyst for the oxidation of ammonia as obtained or obtainable according to any of the particular and preferred embodiments of the inventive process for the preparation of a catalyst for the oxidation of ammonia.

The present invention also relates to the use of a catalyst for the oxidation of ammonia according to any of the particular and preferred embodiments of the present invention, preferably as an ammonia slip catalyst in an emissions treatment system, more preferably as ammonia slip catalyst in a stationary or automotive emissions treatment system, more preferably as an ammonia slip catalyst in an automotive emissions treatment system for the treatment of exhaust gas from a lean burn internal combustion engine, and more preferably as an ammonia slip catalyst in an automotive emissions treatment system for the treatment of exhaust gas from a lean burn gasoline engine or from a diesel engine.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”. Further, it is explicitly noted that the following set of embodiments is not the set of claims determining the extent of protection, but represents a suitably structured part of the description directed to general and preferred aspects of the present invention.
1. A catalyst for the oxidation of ammonia (AMOX catalyst), wherein the catalyst comprises as components:
   (a) Pt and/or Pd as one or more platinum group metals, wherein the one or more platinum group metals are supported on a support material;
   (b) one or more rare earth metal oxides selected from the group of oxides of Pr, Nd, and Ce, including combinations of two or more thereof, wherein preferably the one or more rare earth metal oxides comprise oxides of Pr and/or Nd, preferably oxides of Pr, wherein more preferably the one or more rare earth metal oxides consist of oxides of Pr and/or Nd, preferably oxides of Pr;
   (c) one or more transition metal oxides selected from the group consisting of oxides of Mn, Ti, V, Nb, and Ta, including combinations of two or more thereof;
   (d) one or more zeolitic materials; and
   (e) optionally one or more binders;
   wherein the one or more zeolitic materials are loaded with Cu and/or Fe, preferably with Cu.
2. The catalyst of embodiment 1, wherein the one or more platinum group metals comprise Pt, preferably wherein the one or more platinum group metals consist of Pt.
3. The catalyst of embodiment 1 or 2, wherein the one or more platinum group metals Pt and/or Pd are contained in the catalyst in an amount ranging from 0.003 to 0.87 wt.-% calculated as the element and based on 100 wt.-% of the total amount of the components (a) to (e) contained in the catalyst, preferably from 0.009 to 0.58 wt.-%, more preferably from 0.014 to 0.43 wt.-%, more preferably from 0.023 to 0.29 wt.-%, more preferably from 0.029 to 0.2 wt.-%, more preferably from 0.043 to 0.15 wt.-%, more preferably from 0.058 to 0.12 wt.-%, and more preferably from 0.072 to 0.1 wt.-%.
4. The catalyst of any of embodiments 1 to 3, wherein the one or more platinum group metals Pt and/or Pd are contained in the catalyst at a loading comprised in the range of from 0.1 to 30 g/ft³, preferably from 0.3 to 20 g/ft³, more preferably from 0.5 to 15 g/ft³, more preferably from 0.8 to 10 g/ft³, more preferably from 1 to 7 g/ft³, more preferably from 1.5 to 5 g/ft³, more preferably from 2 to 4 g/ft³, and more preferably from 2.5 to 3.5 g/ft³.
5. The catalyst of any of embodiments 1 to 4, wherein the support material is selected from the group consisting of alumina, silica, silica-alumina, lanthana-alumina, lanthana-silica, lanthana-silica-alumina, baria-alumina, baria-silica, and baria-silica-alumina, including mixtures of two or more thereof, preferably being alumina.
6. The catalyst of any of embodiments 1 to 5, wherein the support material is contained in the catalyst in an amount ranging from 1 to 30 wt.-% calculated as the element and based on 100 wt.-% of the total amount of the components (a) to (e) contained in the catalyst, preferably from 5 to 25 wt.-%, more preferably from 10 to 20 wt.-%, and more preferably from 13 to 17 wt.-%.
7. The catalyst of any of embodiments 1 to 6, wherein the catalyst comprises 1 wt.-% or less of Rh calculated as the element and based on 100 wt.-% of the total amount of the one or more platinum group metals Pt and/or Pd calculated as the element, preferably less than 0.1 wt.-%, more preferably less than 0.01 wt.-%, more preferably less than 0.001 wt.-%, and more preferably less than 0.0001 wt.-%.
8. The catalyst of any of embodiments 1 to 7, wherein the catalyst comprises 1 wt.-% or less of Pd calculated as the element and based on 100 wt.-% of the total amount of the one or more platinum group metals Pt and Pd calculated as the element, preferably less than 0.1 wt.-%, more preferably less than 0.01 wt.-%, more preferably less than 0.001 wt.-%, and more preferably less than 0.0001 wt.-%.
9. The catalyst of any of embodiments 1 to 8, wherein the catalyst comprises 0.25 to 1.75 wt.-% of the one or more rare earth metal oxides calculated as the element and based on 100 wt.-% of the total amount of the components (a) to (e) contained in the catalyst, preferably 0.5 to 1.5 wt.-%, more preferably 0.75 to 1.25 wt.-%, and more preferably 0.9 to 1.1 wt.-%.
10. The catalyst of any of embodiments 1 to 9, wherein the one or more rare earth metal oxides comprise praseodymium oxide, preferably Pr(III,IV) oxide, and more preferably Pr₆O₁₁, wherein more preferably praseodymium oxide is the rare metal oxide, preferably Pr(III,IV) oxide, and more preferably Pr₆O₁₁.
11. The catalyst of any of embodiments 1 to 10, wherein the catalyst comprises 1 to 3.4 wt.-% of the one or more transition metal oxides calculated as MO₂ and based on 100 wt.-% of the total amount of the components (a) to (e) contained in the catalyst, preferably 1.7 to 2.9 wt.-%, and more preferably 2.0 to 2.4 wt.-%.
12. The catalyst of any of embodiments 1 to 11, wherein the one or more transition metal oxides in (c) are selected from the group consisting of MnO₂, TiO₂, VO₂, V₂O₅, Nb₂O₅, and Ta₂O₅, including mixtures of two or more thereof, preferably from the group consisting of MnO₂, TiO₂, VO₂, V₂O₅, and Nb₂O₅, including mixtures of two or more thereof, more preferably from the group consisting of MnO₂, TiO₂, VO₂, and V₂O₅, including mixtures of two or more thereof, more preferably from the group consisting of MnO₂, TiO₂, and VO₂, and V₂O₅, wherein more preferably, the one or more transition metal oxides in (c) comprise MnO₂ and/or TiO₂, wherein more preferably, the one or more transition metal oxides in (c) consist of MnO₂ and/or TiO₂.
13. The catalyst of any of embodiments 1 to 12, wherein the one or more rare earth metal oxides and the one or more transition metal oxides are present as a mixed oxide.
14. The catalyst of any of embodiments 1 to 13, wherein the one or more transition metal oxides comprise MnO₂, wherein the one or more transition metal oxides consist of MnO₂.
15. The catalyst of any of embodiments 1 to 14, wherein the one or more transition metal oxides comprise TiO₂, wherein the one or more transition metal oxides consist of TiO₂.
16. The catalyst of any of embodiments 1 to 15, wherein the one or more transition metal oxides comprise MnO₂ and TiO₂, wherein the one or more transition metal oxides consist of MnO₂ and TiO₂.
17. The catalyst of any of embodiments 1 to 16, wherein the catalyst comprises 65 to 95 wt. % of the one or more zeolitic materials based on 100 wt.-% of the total amount of the components (a) to (e) contained in the catalyst, preferably 70 to 90 wt.-%, more preferably 75 to 85 wt.-%, and more preferably 78 to 82 wt.-%.
18. The catalyst of any of embodiments 1 to 17, wherein the one or more zeolitic materials have a framework-type structure selected from the group consisting of CHA, AEI, RTH, LEV, DDR, KFI, ERI, and AFX, including combinations or mixed structures of two or more thereof, preferably CHA, RTH, and AEI, and more preferably CHA and/or AEI, and more preferably CHA.
19. The catalyst of embodiment 18, wherein the one or more zeolitic materials have a CHA-type framework structure, wherein the one or more zeolitic materials preferably comprise one or more zeolites selected from the group consisting of ZK-14, chabazite, Linde R, Phi, SAPO-34, willhendersonite, SSZ-13, ZYT-6, MeAPO-47, CoAPO-44, MeAPSO-47, SAPO-47, AIPO-34, GaPO-34, Linde D, [Si—O]-CHA, DAF-5, UiO-21, [Zn—As—O]-CHA, [Al—As—O]-CHA, |Co| [Be—P—O]-CHA, (Ni(deta)2)-UT-6, and SSZ-62, more preferably from the group consisting of ZK-14, chabazite, Linde R, Phi, willhendersonite, SSZ-13, ZYT-6, Linde D, [Si—O]-CHA, DAF-5, UiO-21, and SSZ-62, more preferably from the group consisting of chabazite, SSZ-13, and SSZ-62, wherein more preferably the zeolitic material comprises chabazite and/or SSZ-13, preferably SSZ-13, and wherein more preferably the zeolitic material consists of chabazite and/or SSZ-13, preferably of SSZ-13.
20. The catalyst of any of embodiments 1 to 19, wherein the one or more zeolitic materials are loaded with the one or more transition metals in an amount ranging from 1 to 8 wt.-% of the one or more transition metals calculated as the element and based on 100 wt.-% of the one or more zeolitic materials, preferably from 2 to 6 wt.-%, more preferably from 3 to 5 wt.-%, and more preferably from 4 to 4.8 wt.-%.
21. The catalyst of any of embodiments 1 to 20, wherein the one or more zeolitic materials comprise SiO₂ and X₂O₃ in their framework structure, wherein X stands for one or more tetravalent elements.
22. The catalyst of embodiment 21, wherein the one or more tetravalent elements X are selected from the group consisting of Al, B, Ga, and In, including combinations of two or more thereof, preferably from the group consisting of Al, B, and Ga, including combinations of two or more thereof, wherein more preferably X stands for Al and/or B, preferably for Al.
23. The catalyst of embodiment 21 or 22, wherein the SiO₂:X₂O₃ molar ratio of the one or more zeolitic materials is comprised in the range of from 1 to 200, preferably from 5 to 100, more preferably from 10 to 50, more preferably from 15 to 40, more preferably from 20 to 30, more preferably from 23 to 25, and more preferably from 23.5 to 24.
24. The catalyst of any of embodiments 1 to 23, wherein the one or more optional binders are contained in the catalyst in an amount ranging from 1 to 7 wt.-% based on 100 wt.-% of the total amount of the components (a) to (e) contained in the catalyst, preferably from 2 to 6 wt.-%, more preferably from 3 to 5 wt.-%, and more preferably from 3.5 to 4.5 wt.-%.
25. The catalyst of any of embodiments 1 to 24, wherein the one or more binders are selected from the group consisting of ZrO₂, Al₂O₃, and SiO₂, wherein preferably, the one or more binders comprise ZrO₂, wherein more preferably, the one or more binders consist of ZrO₂.
26. The catalyst of any of embodiments 1 to 25, wherein the catalyst further comprises a substrate, wherein the substrate is preferably a monolith substrate, and more preferably a honeycomb substrate.
27. The catalyst of embodiment 26, wherein the substrate is a wall-flow substrate or a flow-through substrate, preferably a flow-through substrate.
28. The catalyst of embodiment 26 or 27, wherein the substrate is a metal substrate or a ceramic substrate, preferably a ceramic substrate, wherein more preferably, the substrate is a cordierite substrate.
29. The catalyst of any of embodiments embodiment 1 to 28, wherein the components (a) to (e) are provided as one or more washcoat layers on the substrate, wherein preferably the components (a) to (e) are comprised in the same washcoat layer, wherein more preferably the substrate is coated with a single washcoat layer comprising the components (a) to (e), wherein more preferably the substrate is coated with a single washcoat layer consisting of the components (a) to (e).
30. An exhaust gas treatment system for the treatment of exhaust gas exiting from an internal combustion engine, preferably from a lean burn internal combustion engine, and more preferably from a lean burn gasoline engine or from a diesel engine, the system comprising an AMOX catalyst according to any of embodiments 1 to 29 and one or more of a diesel oxidation catalyst, a catalyst for the selective catalytic reduction of NOₓ (SCR catalyst), and an optionally catalyzed soot filter.
31. The system of embodiment 30 comprising a diesel oxidation catalyst, an optionally catalyzed soot filter and an SCR catalyst, wherein the diesel oxidation catalyst is positioned upstream of the optionally catalyzed soot filter, wherein the optionally catalyzed soot filter is positioned upstream of the SCR catalyst, and wherein the AMOX catalyst is positioned downstream of the SCR catalyst, wherein the diesel oxidation catalyst preferably is the first catalyst of the system and preferably no catalyst is present between the engine and the diesel oxidation catalyst.
32. The system of embodiment 30 or 31 further comprising a reductant injector, the reductant injector being positioned downstream of the optionally catalyzed soot filter and upstream of the SCR catalyst, wherein the reductant preferably is urea.
33. The system of embodiment 30 comprising a diesel oxidation catalyst, an optionally catalyzed soot filter and an SCR catalyst, wherein the diesel oxidation catalyst is positioned upstream of the SCR catalyst and wherein the SCR catalyst is positioned upstream of the AMOX catalyst, and wherein the AMOX catalyst is positioned upstream of the optionally catalyzed soot filter, wherein the diesel oxidation catalyst preferably is the first catalyst of the system and preferably no catalyst is present between the engine and the diesel oxidation catalyst.
34. The system of embodiment 33 further comprising a reductant injector, the reductant injector being positioned downstream of the diesel oxidation catalyst and upstream of the SCR catalyst, wherein the reductant preferably is urea.
35. The system of embodiment 30 comprising an SCR catalyst and an optionally catalyzed soot filter, wherein the SCR catalyst is positioned upstream of the AMOX catalyst, and the AMOX catalyst is positioned upstream of the optionally catalyzed soot filter, wherein the SCR catalyst preferably is the first catalyst of the system and preferably no catalyst is present between the engine and the catalyst for the selective catalytic reduction of nitrogen oxide.
36. The system of embodiment 35 further comprising a first reductant injector, the first reductant injector being positioned upstream of the SCR catalyst, wherein the reductant preferably is urea.
37. A method for the selective catalytic reduction of NOₓ, wherein the NOₓ is comprised in an exhaust gas stream, said method comprising
   (A) providing the exhaust gas stream, preferably from an internal combustion engine, more preferably from a lean burn internal combustion engine, and more preferably from a lean burn gasoline engine or from a diesel engine;
   (B) passing the exhaust gas stream provided in (A) through an AMOX catalyst according to any of embodiments 1 to 29 and 70 or through an exhaust gas treatment system according to any of embodiments 30 to 36.
38. A process for the preparation of a catalyst for the oxidation of ammonia, preferably of a catalyst for the oxidation of ammonia according to any one of embodiments 1 to 29, wherein the process comprises:
   (1) providing one or more salts of Pt and/or Pd;
   (2) providing one or more support materials;
   (3) impregnating the one or more salts of Pt and/or Pd provided in (1) onto the one or more support materials provided in (2);
   (4) providing one or more transition metal oxides, and/or one or more precursors thereof, wherein the one or more transition metal oxides are selected from the group consisting of oxides of Mn, Ti, V, Nb, and Ta, including combinations of two or more thereof;
   (5) adding the one or more transition metal oxides and/or the one or more precursors thereof provided in (4) to the one or more impregnated support materials obtained in (3) and admixing the resulting mixture;
   (6) providing one or more rare earth metal oxides, and/or one or more precursors thereof, selected from the group of oxides of Pr, Nd, and Ce, including combinations of two or more thereof;
   (7) adding the one or more rare earth metal oxides and/or the one or more precursors thereof provided in (6) to the mixture obtained in (5) and admixing the resulting mixture;
   (8) optionally drying the mixture obtained in (7);
   (9) calcining the mixture obtained in (7) or (8);
   (10) suspending the calcined mixture obtained in (9) in a solvent system;
   (11) optionally milling the suspension obtained in (10);
   (12) providing one or more zeolitic materials;
   (13) optionally providing one or more binders and/or one or more precursors thereof;
   (14) adding the optional one or more binders and/or the one or more precursors thereof provided in (13) to the one or more zeolitic materials provided in (12) and admixing the resulting mixture;
   (15) adding the suspension obtained in (10) or (11) to the mixture obtained in (14) and admixing the resulting mixture for obtaining a slurry;
   (16) providing a substrate;
   (17) coating the slurry obtained in (15) onto the substrate provided in (16) for obtaining a coated substrate;
   (18) optionally drying the coated substrate obtained in (17); and
   (19) calcining the mixture obtained in (17) or (18);
   wherein the one or more zeolitic materials provided in (12) are loaded with Cu and/or Fe, preferably with Cu.
39. The process of embodiment 38, wherein in (2) the one or more support materials display a BET surface area in the range of from 80 to 220 m²/g, wherein preferably the BET surface area is determined according to ISO 9277:2010, preferably from 100 to 200 m²/g, more preferably from 130 to 170 m²/g, and more preferably from 145 to 155 m²/g.
40. The process of embodiment 38 or 39, wherein in (4) the one or more transition metal oxides are selected from the group consisting of MnO₂, TiO₂, VO₂, V₂O₅, Nb₂O₅, and Ta₂O₅, including mixtures of two or more thereof, preferably from the group consisting of MnO₂, TiO₂, VO₂, V₂O₅, and Nb₂O₅, including mixtures of two or more thereof, more preferably from the group consisting of MnO₂, TiO₂, VO₂, and V₂O₅, including mixtures of two or more thereof, and more preferably from the group consisting of MnO₂, TiO₂, and VO₂, and V₂O₅, wherein more preferably, the one or more transition metal oxides comprise MnO₂ and/or TiO₂, wherein more preferably, the one or more transition metal oxides consist of MnO₂ and/or TiO₂.
41. The process of embodiment 38 to 40, wherein in (4) the one or more transition metal oxides comprise TiO₂, and wherein TiO₂ is preferably provided as a hydrogel.
42. The process of any of embodiments 38 to 41, wherein in (4) the one or more transition metal oxides comprise MnO₂, wherein preferably one or more precursors of MnO₂ are provided in (4), wherein more preferably the one or more precursors of MnO₂ comprise one or more salts of Mn(II), wherein more preferably the one or more precursors of MnO₂ comprise manganese nitrate, wherein more preferably manganese nitrate is provided in (4) as the one or more precursors of MnO₂.
43. The process of any of embodiments 38 to 42, wherein in (4) the one or more transition metal oxides comprise TiO₂ and MnO₂, wherein preferably one or more precursors of MnO₂ are provided in (4).
44. The process of any of embodiments 38 to 43, wherein in (5) the one or more transition metal oxides are successively added and admixed to the one or more impregnated support materials.
45. The process of any of embodiments 38 to 44, wherein in (6) the one or more rare earth metal oxides comprise oxides of Pr and/or Nd, preferably oxides of Pr, wherein more preferably in (6) the one or more rare earth metal oxides consist of oxides of Pr and/or Nd, preferably oxides of Pr.
46. The process of any of embodiments 38 to 45, wherein in (6) the one or more rare earth metal oxides comprise praseodymium oxide, wherein preferably one or more precursors of praseodymium oxide are provided in (6), wherein more preferably the one or more precursors of praseodymium oxide comprise one or more salts of Pr(III), wherein more preferably the one or more precursors of praseodymium oxide comprise praseodymium nitrate, wherein more preferably praseodymium nitrate is provided in (6) as the one or more precursors of praseodymium oxide.
47. The process of any of embodiments 38 to 46, wherein in (8) drying is conducted at a temperature comprised in the range of from 40 to 200° C. preferably from 50 to 190° C., more preferably from 60 to 180° C., more preferably from 70 to 170° C., more preferably from 80 to 160° C., more preferably from 90 to 150° C., more preferably from 100 to 140° C., more preferably from 110 to 130° C., more preferably from 115 to 125° C., and more preferably from 118 to 122° C.
48. The process of any of embodiments 38 to 47, wherein in (8) drying is conducted for a duration in the range of from 40 to 200 minutes, preferably from 60 to 180 minutes, more preferably from 70 to 170 minutes, more preferably from 80 to 160 minutes, more preferably from 90 to 150 minutes, more preferably from 100 to 140 minutes, and more preferably from 110 to 130 minutes, and more preferably from 115 to 125 minutes.
49. The process of any of embodiments 38 to 48, wherein in (9) calcination is conducted at a temperature comprised in the range of from 200 to 1000° C., preferably from 300 to 900° C., more preferably from 350 to 850° C., more preferably from 400 to 800° C., more preferably from 450 to 750° C., more preferably from 500 to 700° C., more preferably from 565 to 625° C., and more preferably 580 to 600° C.
50. The process of any of embodiments 38 to 49, wherein in (9) calcination is conducted for a duration in the range of from 40 to 200 minutes, preferably from 60 to 180 minutes, more preferably from 70 to 170 minutes, more preferably from 80 to 160 minutes, more preferably from 90 to 150 minutes, more preferably from 100 to 140 minutes, and more preferably from 110 to 130 minutes, and more preferably from 115 to 125 minutes.
51. The process of any of embodiments 38 to 50, wherein in (10) the solvent system comprises destilled water, wherein distilled water is used as the solvent system in (10).
52. The process of any of embodiments 38 to 51, wherein in (11) the suspension obtained in (10) is milled to a particle size Dv90 comprised in the range of from 1 to 30 μm, wherein preferably the particle size Dv90 is determined according to ISO 13320:2020, preferably from 5 to 25 μm, more preferably from 10 to 20 μm, and more preferably from 13 to 17 μm.
53. The process of any of embodiments 38 to 52, wherein in (12) the one or more zeolitic materials have a framework-type structure selected from the group consisting of CHA, AEI, RTH, LEV, DDR, KFI, ERI, and AFX, including combinations or mixed structures of two or more thereof, preferably from the group consisting of CHA, RTH, and AEI, including combinations or mixed structures of two or more thereof, wherein more preferably in (12) the one or more zeolitic materials have a CHA and/or AEI framework-type structure, and more preferably a CHA framework-type structure.
54. The process of embodiment 53, wherein in (12) the one or more zeolitic materials have a CHA-type framework structure, wherein the one or more zeolitic materials preferably comprise one or more zeolites selected from the group consisting of ZK-14, chabazite, Linde R, Phi, SAPO-34, willhendersonite, SSZ-13, ZYT-6, MeAPO-47, CoAPO-44, MeAPSO-47, SAPO-47, AIPO-34, GaPO-34, Linde D, [Si—O]-CHA, DAF-5, UiO-21, [Zn—As—O]-CHA, [Al—As—O]-CHA, |Co| [Be—P—O]-CHA, (Ni(deta)2)-UT-6, and SSZ-62, more preferably from the group consisting of ZK-14, chabazite, Linde R, Phi, willhendersonite, SSZ-13, ZYT-6, Linde D, [Si—O]-CHA, DAF-5, UiO-21, and SSZ-62, more preferably from the group consisting of chabazite, SSZ-13, and SSZ-62, wherein more preferably the zeolitic material comprises chabazite and/or SSZ-13, preferably SSZ-13, and wherein more preferably the zeolitic material consists of chabazite and/or SSZ-13, preferably of SSZ-13.
55. The process of any of embodiments 38 to 4, wherein in (12) the one or more zeolitic materials are loaded with the one or more transition metals in an amount ranging from 1 to 8 wt.-% of the one or more transition metals calculated as the element and based on 100 wt.-% of the one or more zeolitic materials, preferably from 2 to 6 wt.-%, more preferably from 3 to 5 wt.-%, and more preferably from 4 to 4.8 wt.-%.
56. The process of any of embodiments 38 to 55, wherein in (12) the one or more zeolitic materials comprise SiO₂ and X₂O₃ in their framework structure, wherein X stands for one or more tetravalent elements.
57. The process of embodiment 56, wherein in (12) the one or more tetravalent elements X are selected from the group consisting of Al, B, Ga, and In, including combinations of two or more thereof, preferably from the group consisting of Al, B, and Ga, including combinations of two or more thereof, wherein more preferably X stands for Al and/or B, preferably for Al.
58. The process of embodiment 56 or 57, wherein in (12) the SiO₂:X₂O₃ molar ratio of the one or more zeolitic materials is comprised in the range of from 1 to 200, preferably from 5 to 100, more preferably from 10 to 50, more preferably from 15 to 40, more preferably from 20 to 30, more preferably from 23 to 25, and more preferably from 23.5 to 24.
59. The process of any of embodiments 38 to 58, wherein in (12) the one or more zeolitic materials display a particle size Dv90 comprised in the range of from 1 to 10 μm, wherein preferably the particle size Dv90 is determined according to ISO 13320:2020, preferably from 3 to 8 μm, more preferably from 6 to 7, and more preferably from 6.5 to 5.5 μm
60. The process of any of embodiments 38 to 59, wherein in (13) the one or more binders are selected from the group consisting of ZrO₂, Al₂O₃, and SiO₂, wherein preferably, the one or more binders comprise ZrO₂, wherein more preferably, the one or more binders consist of ZrO₂.
61. The process of any of embodiments 38 to 60, wherein in (13) the one or more binders comprise ZrO₂, wherein preferably one or more precursors of ZrO₂ are provided in (13), wherein more preferably the one or more precursors of ZrO₂ comprise one or more salts of Zr(IV), wherein more preferably the one or more precursors of ZrO₂ comprise zirconium acetate, wherein more preferably zirconium acetate is provided in (13) as the one or more precursors of ZrO₂.
62. The process of any of embodiments 38 to 61, wherein admixing in (14) is conducted for a period comprised in the range of from 4 to 20 hours, preferably from 6 to 18 hours, more preferably from 8 to 16 hours, more preferably from 10 to 14 hours, and more preferably from 11 to 13 hours.
63. The process of any of embodiments 38 to 62, wherein in (16) the substrate is a monolith substrate, and is preferably a honeycomb substrate.
64. The process of embodiment 63, wherein the substrate is a wall-flow substrate or a flow-through substrate, preferably a flow-through substrate.
65. The process of embodiment 63 or 64, wherein the substrate is a metal substrate or a ceramic substrate, preferably a ceramic substrate, wherein more preferably, the substrate is a cordierite substrate.
66. The process of any of embodiments 38 to 65, wherein in (8) drying is conducted at a temperature comprised in the range of from 40 to 200° C., preferably from 50 to 190° C., more preferably from 60 to 180° C., more preferably from 70 to 170° C., more preferably from 80 to 160° C., more preferably from 90 to 150° C., more preferably from 100 to 140° C., more preferably from 110 to 130° C., more preferably from 115 to 125° C., and more preferably from 118 to 122° C.
67. The process of any of embodiments 38 to 66, wherein in (8) drying is conducted for a duration in the range of from 40 to 200 minutes, preferably from 60 to 180 minutes, more preferably from 70 to 170 minutes, more preferably from 80 to 160 minutes, more preferably from 90 to 150 minutes, more preferably from 100 to 140 minutes, and more preferably from 110 to 130 minutes, and more preferably from 115 to 125 minutes.
68. The process of any of embodiments 38 to 67, wherein in (9) calcination is conducted at a temperature comprised in the range of from 300 to 900° C., preferably from 350 to 850° C., more preferably from 400 to 800° C., more preferably from 450 to 750° C., more preferably from 500 to 700° C., more preferably from 550 to 650° C., more preferably from 590 to 610° C. and more preferably from 598 to 602° C.
69. The process of any of embodiments 38 to 68, wherein in (9) calcination is conducted for a duration in the range of from 40 to 200 minutes, preferably from 60 to 180 minutes, more preferably from 70 to 170 minutes, more preferably from 80 to 160 minutes, more preferably from 90 to 150 minutes, more preferably from 100 to 140 minutes, and more preferably from 110 to 130 minutes, and more preferably from 115 to 125 minutes.
70. A catalyst for the oxidation of ammonia as obtained or obtainable according to any of embodiments 38 to 69.
71. Use of a catalyst according to any of embodiments 1 to 29 and 70 for the oxidation of ammonia, preferably as an ammonia slip catalyst in an emissions treatment system, more preferably as ammonia slip catalyst in a stationary or automotive emissions treatment system, more preferably as an ammonia slip catalyst in an automotive emissions treatment system for the treatment of exhaust gas from a lean burn internal combustion engine, and more preferably as an ammonia slip catalyst in an automotive emissions treatment system for the treatment of exhaust gas from a lean burn gasoline engine or from a diesel engine.

### DESCRIPTION OF THE FIGURES

FIG. 1 displays the results from catalytic testing in Example 6, wherein the amount of NOx and N₂O in g/l exiting the exhaust system including an AMOX catalyst according to Examples 3 to 5 and Comparative Examples 1, 2, 4, and 5 is indicated on the left hand side, and the HN₃ T50 light off temperature in ° C. is shown on the right hand side.

FIG. 2 displays the results from catalytic testing in Example 6, wherein the amount of NOx and N₂O in g/l exiting the exhaust system including an AMOX catalyst according to Examples 1 and 2 and Comparative Example 3 is indicated on the left hand side, and the HN₃ T50 light off temperature in ° C. is shown on the right hand side.

### EXAMPLES

### Example 1: Preparation of a Pt-Only AMOX Catalyst

Pt-Alumina Suspension

In a container, 24 g of a solution of platinum amine salt (with 17 weight-% of Pt) was mixed with 120 ml of deionized water. This mixture was added dropwise onto 716 g of an alumina powder (gamma Al₂O₃, BET specific surface area of 150 m²/g, a pore volume 0.9-1 ml/cm³, an average pore size of 10-15 nanometers).

To this Pt/alumina mixture, 300 g of a TiO₂ hydrogel (with 18.5 weight-% of TiO₂ based on the weight of the hydrogel) was added dropwise under vigorous mixing with an Eirich mixer. Afterwards, 261 g of a manganese nitrate solution (with a Mn content of 21.3 weight-%, calculated as MnO, based on the weight of the solution) was added dropwise under vigorous mixing. Further, 146 g of a praseodymium nitrate solution (with a Pr content of 38 weight-%, calculated as Pr₆O₁₁, based on the weight of the solution) was added dropwise under vigorous mixing.

The resulting mixture was dried for 2 h at 120° C. and then calcined in a box oven for 2 h at 590° C. in air, obtaining a powder. The calcined powder was added into 1.2 kg of deionized water. Afterwards, the obtained suspension was milled with a ball mill so that the particles of the suspension had a Dv90 of 15 micrometers.

Zeolite Suspension

193 g of CuO (99%) was added to 2.18 Kg deionized water and milled in a ball mill to achieve a D50 of 1.9 micron. The resulting suspension is added into 2 Kg of deionized water and subsequently 3.83 kg of a H-SSZ-13 zeolitic material (with a SiO₂:Al₂O₃ molar ratio of 25, a BET specific surface area of about 500-600 m²/g, and a Dv90 of 5 micrometers) was added, as a result of which the CuO was dissolved and subsequently ion-exchanged into the zeolite. Eventually 0.58 Kg of a zirconia acetate solution with a content of 17% ZrO₂ was added and the mixture was stirred for 12 h.

After this time the Pt alumina suspension was added to the zeolite suspension and the mixture was mixed thoroughly for 30 min.

An uncoated honeycomb flow-through ceramic monolith substrate (cordierite—diameter: 2.54 cm (1 inch)×length: 10.16 cm (4 inches) cylindrically shaped substrate with 400/(2.54)² cells per square centimeter and 0.1 millimeter (4 mil) wall thickness) was dip coated with the obtained suspension over 100% of the length of the substrate. The coated substrate was dried at 120° C. for 2 hours and calcined in air for 2 hours at 600° C. The final loading of the coating in the catalyst after calcination was 2 g/in³, including 0.3 g/in³ of alumina, 0.024 g/in³ of titania, 0.02 g/in³ of MnO₂, 0.024 g/in³ of Pr₆O₁₁, 1.6 g/in³ CuCHA (including 5.5% copper calculated as CuO), 0.08 g/in³ ZrO₂, 3 g/ft³ of Pt.

### Example 2: Preparation of a Pt-Only AMOX Catalyst Comprising Cu-CHA

Pt-Alumina Suspension

In a container, 24 g of a solution of platinum amine salt (with 17 weight-% of Pt) was mixed with 120 ml of deionized water. This mixture was added dropwise onto 716 g of an alumina powder (gamma Al₂O₃, BET specific surface area of 150 m²/g, a pore volume 0.9-1 ml/cm³, an average pore size of 10-15 nanometers).

Afterwards, 261 g of a manganese nitrate solution (with a Mn content of 21.3 weight-%, calculated as MnO, based on the weight of the solution) was diluted with 150 ml deionized water was added dropwise under vigorous mixing. Further, 146 g of a praseodymium nitrate solution (with a Pr content of 38 weight-%, calculated as Pr₆O₁₁, based on the weight of the solution) was diluted with 300 ml deionized water and added dropwise under vigorous mixing.

The resulting mixture was dried for 2 h at 120° C. and then calcined in a box oven for 2 h at 590° C. in air, obtaining a powder. The calcined powder was added into 1.2 kg of deionized water. Afterwards, the obtained suspension was milled with a ball mill so that the particles of the suspension had a Dv90 of 15 micrometers.

Zeolite Suspension

193 g of CuO (99%) was added to 2.18 Kg deionized water and milled in a ball mill to achieve a D50 of 1.9 micron. The resulting suspension is added into 2 Kg of deionized water and subsequently 3.83 kg of a H-SSZ-13 zeolitic material (with a SiO₂:Al₂O₃ molar ratio of 25, a BET specific surface area of about 500-600 m²/g, and a Dv90 of 5 micrometers) was added, as a result of which the CuO was dissolved and subsequently ion-exchanged into the zeolite. Eventually 0.58 Kg of a zirconia acetate solution with a content of 17% ZrO₂ was added and the mixture was stirred for 12 h.

After this time the Pt alumina suspension was added to the zeolite suspension and the mixture was mixed thoroughly for 30 min.

An uncoated honeycomb flow-through ceramic monolith substrate (cordierite—diameter: 2.54 cm (1 inch)×length: 10.16 cm (4 inches) cylindrically shaped substrate with 400/(2.54)² cells per square centimeter and 0.1 millimeter (4 mil) wall thickness) was dip coated with the obtained suspension over 100% of the length of the substrate. The coated substrate was dried at 120° C. for 2 hours and calcined in air for 2 hours at 600° C. The final loading of the coating in the catalyst after calcination was 2 g/in³, including 0.3 g/in³ of alumina, 0.02 g/in³ of MnO₂, 0.024 g/in³ of Pr₆O₁₁, 1.6 g/in³ CuCHA (including 5.5% copper calculated as CuO), 0.08 g/in³ ZrO₂, 3 g/ft³ of Pt.

### Example 3: Preparation of a Pt-Only AMOX Catalyst Comprising Cu-CHA

Pt-Alumina Suspension

In a container, 24 g of a solution of platinum amine salt (with 17 weight-% of Pt) was mixed with 120 ml of deionized water. This mixture was added dropwise onto 716 g of an alumina powder (gamma Al₂O₃, BET specific surface area of 150 m²/g, a pore volume 0.9-1 ml/cm³, an average pore size of 10-15 nanometers).

To this Pt/alumina mixture, 300 g of a TiO₂ hydrogel (with 18 weight-% of TiO₂ based on the weight of the hydrogel) was added dropwise under vigorous mixing with an Eirich mixer. Afterwards, 130 g of a manganese nitrate solution (with a Mn content of 21.3 weight-%, calculated as MnO, based on the weight of the solution) was diluted with 50 ml of deionized water and added dropwise under vigorous mixing. Further, 73 g of a praseodymium nitrate solution (with a Pr content of 38 weight-%, calculated as Pr₆O₁₁, based on the weight of the solution) was also diluted with 50 ml of deionized water and added dropwise under vigorous mixing.

The resulting mixture was dried for 2 h at 120° C. and then calcined in a box oven for 2 h at 590° C. in air, obtaining a powder. The calcined powder was added into 1.2 kg of deionized water. Afterwards, the obtained suspension was milled with a ball mill so that the particles of the suspension had a Dv90 of 15 micrometers.

Zeolite Suspension

193 g of CuO (99%) was added to 2.18 Kg deionized water and milled in a ball mill to achieve a D50 of 1.9 micron. The resulting suspension is added into 2 Kg of deionized water and subsequently 3.83 kg of a H-SSZ-13 zeolitic material (with a SiO₂:Al₂O₃ molar ratio of 25, a BET specific surface area of about 500-600 m²/g, and a Dv90 of 5 micrometers) was added, as a result of which the CuO was dissolved and subsequently ion-exchanged into the zeolite. Eventually 0.58 Kg of a zirconia acetate solution with a content of 17% ZrO₂ was added and the mixture was stirred for 12 h.

After this time the Pt alumina suspension was added to the zeolite suspension and the mixture was mixed thoroughly for 30 min.

An uncoated honeycomb flow-through ceramic monolith substrate (cordierite—diameter: 2.54 cm (1 inch)×length: 10.16 cm (4 inches) cylindrically shaped substrate with 400/(2.54)² cells per square centimeter and 0.1 millimeter (4 mil) wall thickness) was dip coated with the obtained suspension over 100% of the length of the substrate. The coated substrate was dried at 120° C. for 2 hours and calcined in air for 2 hours at 600° C. The final loading of the coating in the catalyst after calcination was 2 g/in³, including 0.3 g/in³ of alumina, 0.024 g/in³ of titania, 0.01 g/in³ of MnO₂, 0.012 g/in³ of Pr₆O₁₁, 1.6 g/in³ CuCHA (including 5.5% copper calculated as CuO), 0.08 g/in³ ZrO₂, 3 g/ft³ of Pt.

### Example 4: Preparation of a Pt-Only AMOX Catalyst Comprising Cu-CHA

Pt-Alumina Suspension

In a container, 24 g of a solution of platinum amine salt (with 17 weight-% of Pt) was mixed with 120 ml of deionized water. This mixture was added dropwise onto 716 g of an alumina powder (gamma Al₂O₃, BET specific surface area of 150 m²/g, a pore volume 0.9-1 ml/cm³, an average pore size of 10-15 nanometers).

To this Pt/alumina mixture, 300 g of a TiO₂ hydrogel (with 18.5 weight-% of TiO₂ based on the weight of the hydrogel) was added dropwise under vigorous mixing with an Eirich mixer. Afterwards, 65 g of a manganese nitrate solution (with a Mn content of 21.3 weight-%, calculated as MnO, based on the weight of the solution) was diluted with 100 ml of deionized water and added dropwise under vigorous mixing. Further, 146 g of a praseodymium nitrate solution (with a Pr content of 38 weight-%, calculated as Pr₆O₁₁, based on the weight of the solution) was diluted with 50 ml of deionized water and added dropwise under vigorous mixing.

The resulting mixture was dried for 2 h at 120° C. and then calcined in a box oven for 2 h at 590° C. in air, obtaining a powder. The calcined powder was added into 1.2 kg of deionized water. Afterwards, the obtained suspension was milled with a ball mill so that the particles of the suspension had a Dv90 of 15 micrometers.

Zeolite Suspension

193 g of CuO (99%) was added to 2.18 Kg deionized water and milled in a ball mill to achieve a D50 of 1.9 micron. The resulting suspension is added into 2 Kg of deionized water and subsequently 3.83 kg of a H-SSZ-13 zeolitic material (with a SiO₂:Al₂O₃ molar ratio of 25, a BET specific surface area of about 500-600 m²/g, and a Dv90 of 5 micrometers) was added, as a result of which the CuO was dissolved and subsequently ion-exchanged into the zeolite. Eventually 0.58 Kg of a zirconia acetate solution with a content of 17% ZrO₂ was added and the mixture was stirred for 12 h.

After this time the Pt alumina suspension was added to the zeolite suspension and the mixture was mixed thoroughly for 30 min.

An uncoated honeycomb flow-through ceramic monolith substrate (cordierite—diameter: 2.54 cm (1 inch)×length: 10.16 cm (4 inches) cylindrically shaped substrate with 400/(2.54)² cells per square centimeter and 0.1 millimeter (4 mil) wall thickness) was dip coated with the obtained suspension over 100% of the length of the substrate. The coated substrate was dried at 120° C. for 2 hours and calcined in air for 2 hours at 600° C. The final loading of the coating in the catalyst after calcination was 2 g/in³, including 0.3 g/in³ of alumina, 0.024 g/in³ of titania, 0.02 g/in³ of MnO₂, 0.006 g/in³ of Pr₆O₁₁, 1.6 g/in³ CuCHA (including 5.5% copper calculated as CuO), 0.08 g/in³ ZrO₂, 3 g/ft³ of Pt.

### Example 5: Preparation of a Pt-Only AMOX Catalyst Comprising Cu-CHA Yet Devoid of Manganese Dioxide

Pt-Alumina Suspension

In a container, 24 g of a solution of platinum amine salt (with 17 weight-% of Pt) was mixed with 120 ml of deionized water. This mixture was added dropwise onto 716 g of an alumina powder (gamma Al₂O₃, BET specific surface area of 150 m²/g, a pore volume 0.9-1 ml/cm³, an average pore size of 10-15 nanometers).

To this Pt/alumina mixture, 300 g of a TiO₂ hydrogel (with 18.5 weight-% of TiO₂ based on the weight of the hydrogel) was added dropwise under vigorous mixing with an Eirich mixer. Subsequently, 146 g of a Praseodymium nitrate solution (with a Pr content of 38 weight-%, calculated as Pr₆O₁₁, based on the weight of the solution) was diluted with 200 ml of deionized water and added dropwise under vigorous mixing.

The resulting mixture was dried for 2 h at 120° C. and then calcined in a box oven for 2 h at 590° C. in air, obtaining a powder. The calcined powder was added into 1.2 kg of deionized water. Afterwards, the obtained suspension was milled with a ball mill so that the particles of the suspension had a Dv90 of 15 micrometers.

Zeolite Suspension

193 g of CuO (99%) was added to 2.18 Kg deionized water and milled in a ball mill to achieve a D50 of 1.9 micron. The resulting suspension is added into 2 Kg of deionized water and subsequently 3.83 kg of a H-SSZ-13 zeolitic material (with a SiO₂:Al₂O₃ molar ratio of 25, a BET specific surface area of about 500-600 m²/g, and a Dv90 of 5 micrometers) was added, as a result of which the CuO was dissolved and subsequently ion-exchanged into the zeolite. Eventually 0.58 Kg of a zirconia acetate solution with a content of 17% ZrO₂ was added and the mixture was stirred for 12 h.

After this time the Pt alumina suspension was added to the zeolite suspension and the mixture was mixed thoroughly for 30 min.

An uncoated honeycomb flow-through ceramic monolith substrate (cordierite—diameter: 2.54 cm (1 inch)×length: 10.16 cm (4 inches) cylindrically shaped substrate with 400/(2.54)² cells per square centimeter and 0.1 millimeter (4 mil) wall thickness) was dip coated with the obtained suspension over 100% of the length of the substrate. The coated substrate was dried at 120° C. for 2 hours and calcined in air for 2 hours at 600° C. The final loading of the coating in the catalyst after calcination was 2 g/in³, including 0.3 g/in³ of alumina, 0.024 g/in³ of titania, 0.024 g/in³ of Pr₆O₁₁, 1.6 g/in³ CuCHA (including 5.5% copper calculated as CuO), 0.08 g/in³ ZrO₂, 3 g/ft³ of Pt.

### Comparative Example 1: Preparation of a Pt-Only AMOX Catalyst Comprising Cu-CHA Yet Devoid of Praseodymium Oxide

Pt-Alumina Suspension

In a container, 24 g of a solution of platinum amine salt (with 17 weight-% of Pt) was mixed with 120 ml of deionized water. This mixture was added dropwise onto 716 g of an alumina powder (gamma Al₂O₃, BET specific surface area of 150 m²/g, a pore volume 0.9-1 ml/cm³, an average pore size of 10-15 nanometers).

To this Pt/alumina mixture, 300 g of a TiO₂ hydrogel (with 18.5 weight-% of TiO₂ based on the weight of the hydrogel) was added dropwise under vigorous mixing with an Eirich mixer. Afterwards, 261 g of a manganese nitrate solution (with a Mn content of 21.3 weight-%, calculated as MnO, based on the weight of the solution) was diluted with 100 ml of deionized water and added dropwise under vigorous mixing.

The resulting mixture was dried for 2 h at 120° C. and then calcined in a box oven for 2 h at 590° C. in air, obtaining a powder. The calcined powder was added into 1.2 kg of deionized water. Afterwards, the obtained suspension was milled with a ball mill so that the particles of the suspension had a Dv90 of 15 micrometers.

Zeolite Suspension

193 g of CuO (99%) was added to 2.18 Kg deionized water and milled in a ball mill to achieve a D50 of 1.9 micron. The resulting suspension is added into 2 Kg of deionized water and subsequently 3.83 kg of a H-SSZ-13 zeolitic material (with a SiO₂:Al₂O₃ molar ratio of 25, a BET specific surface area of about 500-600 m²/g, and a Dv90 of 5 micrometers) was added, as a result of which the CuO was dissolved and subsequently ion-exchanged into the zeolite. Eventually 0.58 Kg of a zirconia acetate solution with a content of 17% ZrO₂ was added and the mixture was stirred for 12 h.

After this time the Pt alumina suspension was added to the zeolite suspension and the mixture was mixed thoroughly for 30 min.

An uncoated honeycomb flow-through ceramic monolith substrate (cordierite—diameter: 2.54 cm (1 inch)×length: 10.16 cm (4 inches) cylindrically shaped substrate with 400/(2.54)² cells per square centimeter and 0.1 millimeter (4 mil) wall thickness) was dip coated with the obtained suspension over 100% of the length of the substrate. The coated substrate was dried at 120° C. for 2 hours and calcined in air for 2 hours at 600° C. The final loading of the coating in the catalyst after calcination was 2 g/in³, including 0.3 g/in³ of alumina, 0.024 g/in³ of titania, 0.02 g/in³ of MnO₂, 1.6 g/in³ CuCHA (including 5.5% copper calculated as CuO), 0.08 g/in³ ZrO₂, 3 g/ft³ of Pt.

### Comparative Example 2: Preparation of a Pt-Only AMOX Catalyst Comprising Cu-CHA Yet Devoid of Mn and Pr Oxides

Pt-Alumina Suspension

In a container, 24 g of a solution of platinum amine salt (with 17 weight-% of Pt) was mixed with 120 ml of deionized water. This mixture was added dropwise onto 716 g of an alumina powder (gamma Al₂O₃, BET specific surface area of 150 m²/g, a pore volume 0.9-1 ml/cm³, an average pore size of 10-15 nanometers).

To this Pt/alumina mixture, 300 g of a TiO₂ hydrogel was mixed with 260 ml deionized water (with 18.5 weight-% of TiO₂ based on the weight of the hydrogel) and added dropwise under vigorous mixing with an Eirich mixer.

The resulting mixture was dried for 2 h at 120° C. and then calcined in a box oven for 2 h at 590° C. in air, obtaining a powder. The calcined powder was added into 1.2 kg of deionized water. Afterwards, the obtained suspension was milled with a ball mill so that the particles of the suspension had a Dv90 of 15 micrometers.

Zeolite Suspension

193 g of CuO (99%) was added to 2.18 Kg deionized water and milled in a ball mill to achieve a D50 of 1.9 micron. The resulting suspension is added into 2 Kg of deionized water and subsequently 3.83 kg of a H-SSZ-13 zeolitic material (with a SiO₂:Al₂O₃ molar ratio of 25, a BET specific surface area of about 500-600 m²/g, and a Dv90 of 5 micrometers) was added, as a result of which the CuO was dissolved and subsequently ion-exchanged into the zeolite. Eventually 0.58 Kg of a zirconia acetate solution with a content of 17% ZrO₂ was added and the mixture was stirred for 12 h.

After this time the Pt alumina suspension was added to the zeolite suspension and the mixture was mixed thoroughly for 30 min.

An uncoated honeycomb flow-through ceramic monolith substrate (cordierite—diameter: 2.54 cm (1 inch)×length: 10.16 cm (4 inches) cylindrically shaped substrate with 400/(2.54)² cells per square centimeter and 0.1 millimeter (4 mil) wall thickness) was dip coated with the obtained suspension over 100% of the length of the substrate. The coated substrate was dried at 120° C. for 2 hours and calcined in air for 2 hours at 600° C. The final loading of the coating in the catalyst after calcination was 2 g/in³, including 0.3 g/in³ of alumina, 0.024 g/in³ of titania, 1.6 g/in³ CuCHA (including 5.5% copper calculated as CuO), 0.08 g/in³ ZrO₂, 3 g/ft³ of Pt.

### Comparative Example 3: Preparation of a Pt-Only AMOX Catalyst Comprising Cu-CHA Yet Devoid of Praseodymium Oxide

Pt-Alumina Suspension

In a container, 24 g of a solution of platinum amine salt (with 17 weight-% of Pt) was mixed with 120 ml of deionized water. This mixture was added dropwise onto 716 g of an alumina powder (gamma Al₂O₃, BET specific surface area of 150 m²/g, a pore volume 0.9-1 ml/cm³, an average pore size of 10-15 nanometers).

To this Pt/alumina mixture, 150 g of a TiO₂ hydrogel (with 18.5 weight-% of TiO₂ based on the weight of the hydrogel) was diluted with 200 ml of deionized water and added dropwise under vigorous mixing with an Eirich mixer. Afterwards, 141 g of a manganese nitrate solution (with a Mn content of 21.3 weight-%, calculated as MnO, based on the weight of the solution) was diluted with 150 ml of deionized water added dropwise under vigorous mixing.

The resulting mixture was dried for 2 h at 120° C. and then calcined in a box oven for 2 h at 590° C. in air, obtaining a powder. The calcined powder was added into 1.2 kg of deionized water. Afterwards, the obtained suspension was milled with a ball mill so that the particles of the suspension had a Dv90 of 15 micrometers.

Zeolite Suspension

193 g of CuO (99%) was added to 2.18 Kg deionized water and milled in a ball mill to achieve a D50 of 1.9 micron. The resulting suspension is added into 2 Kg of deionized water and subsequently 3.83 kg of a H-SSZ-13 zeolitic material (with a SiO₂:Al₂O₃ molar ratio of 25, a BET specific surface area of about 500-600 m²/g, and a Dv90 of 5 micrometers) was added, as a result of which the CuO was dissolved and subsequently ion-exchanged into the zeolite. Eventually 0.58 Kg of a zirconia acetate solution with a content of 17% ZrO₂ was added and the mixture was stirred for 12 h.

After this time the Pt alumina suspension was added to the zeolite suspension and the mixture was mixed thoroughly for 30 min.

An uncoated honeycomb flow-through ceramic monolith substrate (cordierite—diameter: 2.54 cm (1 inch)×length: 10.16 cm (4 inches) cylindrically shaped substrate with 400/(2.54)² cells per square centimeter and 0.1 millimeter (4 mil) wall thickness) was dip coated with the obtained suspension over 100% of the length of the substrate. The coated substrate was dried at 120° C. for 2 hours and calcined in air for 2 hours at 600° C. The final loading of the coating in the catalyst after calcination was 2 g/in³, including 0.3 g/in³ of alumina, 0.01 g/in³ of titania, 0.008 g/in³ of MnO₂, 1.6 g/in³ CuCHA (including 5.5% copper calculated as CuO), 0.08 g/in³ ZrO₂, 3 g/ft³ of Pt.

### Comparative Example 4: Preparation of a Pt-Only AMOX Catalyst Comprising Cu-CHA Yet Devoid of Ti, Pr, and Mn Oxides

Pt-Alumina Suspension

In another container, 24 g of a solution of platinum amine salt (with 17 weight-% of Pt) was mixed with 560 ml of deionized water. This mixture was added dropwise onto 716 g of an alumina powder doped with 20% of zirconia (having a BET specific surface area of 200 m²/g, an average pore volume of about 0.7 ml/cm³, an average pore size of 5 nanometers). The resulting mixture was dried for 2 h at 120° C. and then calcined in a box oven for 2 h at 600° C. in air. The calcined powder was added into 4.5 kg of deionized water. Afterwards, the obtained suspension was milled with a ball mill so that the particles of the suspension had a Dv90 of 15 micrometers.

Zeolite Suspension

193 g of CuO (99%) was added to 2.18 Kg deionized water and milled in a ball mill to achieve a D50 of 1.9 micron. The resulting suspension is added into 2 Kg of deionized water and subsequently 3.83 kg of a H-SSZ-13 zeolitic material (with a SiO₂:Al₂O₃ molar ratio of 25, a BET specific surface area of about 500-600 m²/g, and a Dv90 of 5 micrometers) was added, as a result of which the CuO was dissolved and subsequently ion-exchanged into the zeolite. Eventually 0.58 Kg of a zirconia acetate solution with a content of 17% ZrO₂ was added and the mixture was stirred for 12 h.

After this time the Pt alumina suspension was added to the zeolite suspension and the mixture was mixed thoroughly for 30 min.

An uncoated honeycomb flow-through ceramic monolith substrate (cordierite—diameter: 2.54 cm (1 inch)×length: 10.16 cm (4 inches) cylindrically shaped substrate with 400/(2.54)² cells per square centimeter and 0.1 millimeter (4 mil) wall thickness) was dip coated with the obtained suspension over 100% of the length of the substrate. The coated substrate was dried at 120° C. for 2 hours and calcined in air for 2 hours at 600° C. The final loading of the coating in the catalyst after calcination was 2 g/in³, including 0.25 g/in³ of alumina (doped with zirconia), 1.6 g/in³ CuCHA (including 5.5% copper calculated as CuO), 0.08 g/in³ ZrO₂, 3 g/ft³ of Pt.

### Comparative Example 5: Preparation of a Pt/Rh AMOX Catalyst Comprising Cu-CHA Pt/Rh-Alumina Suspension

In a container, 24 g of a solution of platinum amine salt (with 17 weight-% of Pt) was mixed with 120 ml of deionized water. This mixture was added dropwise onto 716 g of an alumina powder (gamma Al₂O₃, BET specific surface area of 150 m²/g, a pore volume 0.9-1 ml/cm³, an average pore size of 10-15 nanometers). Subsequently 4.1 ml of a solution of rhodium-nitrate (with 10 weight-% of Rh based on the weight of the solution) was diluted with 50 ml of deionized water and added dropwise onto the Pt-alumina mixture.

To this Pt/Rh/alumina mixture, 150 g of a TiO₂ hydrogel (with 18.5 weight-% of TiO₂ based on the weight of the hydrogel) was diluted with 230 ml of deionized water and added dropwise under vigorous mixing with an Eirich mixer. Afterwards, 141 g of a manganese nitrate solution (with a Mn content of 21.3 weight-%, calculated as MnO, based on the weight of the solution) was diluted with 150 ml deionized water and added dropwise under vigorous mixing.

The resulting mixture was dried for 2 h at 120° C. and then calcined in a box oven for 2 h at 590° C. in air, obtaining a powder. The calcined powder was added into 1.2 kg of deionized water. Afterwards, the obtained suspension was milled with a ball mill so that the particles of the suspension had a Dv90 of 15 micrometers.

Zeolite Suspension

193 g of CuO (99%) was added to 2.18 Kg deionized water and milled in a ball mill to achieve a D50 of 1.9 micron. The resulting suspension is added into 2 Kg of deionized water and subsequently 3.83 kg of a H-SSZ-13 zeolitic material (with a SiO₂:Al₂O₃ molar ratio of 25, a BET specific surface area of about 500-600 m²/g, and a Dv90 of 5 micrometers) was added, as a result of which the CuO was dissolved and subsequently ion-exchanged into the zeolite. Eventually 0.58 Kg of a zirconia acetate solution with a content of 17% ZrO₂ was added and the mixture was stirred for 12 h.

After this time the Pt alumina suspension was added to the zeolite suspension and the mixture was mixed thoroughly for 30 min.

An uncoated honeycomb flow-through ceramic monolith substrate (cordierite—diameter: 2.54 cm (1 inch)×length: 10.16 cm (4 inches) cylindrically shaped substrate with 400/(2.54)² cells per square centimeter and 0.1 millimeter (4 mil) wall thickness) was dip coated with the obtained suspension over 100% of the length of the substrate. The coated substrate was dried at 120° C. for 2 hours and calcined in air for 2 hours at 600° C. The final loading of the coating in the catalyst after calcination was 2 g/in³, including 0.3 g/in³ of alumina, 0.01 g/in³ of titania, 0.008 g/in³ of MnO₂, 1.6 g/in³ CuCHA (including 5.5% copper calculated as CuO), 0.08 g/in³ ZrO₂, 7 g/ft³ of Pt, and 3 g/ft³ of Rh.

### Example 6: Catalyst Testing

The test was performed with a laboratory reactor that consists of a heated tube that contains the test sample with a size of 1 inch diameter and four inch length. The test procedure starts with a heating period of 8 min at 600° C. with a feed gas of 12% O₂, 4% H₂O, 4% CO₂ in N₂ at a space velocity of 90 k h-1. Subsequently the inlet temperature is adjusted to 150° C. and after reaching stable conditions the feed gas concentration was set to 220 ppm NH₃, 12% O₂, 4% H₂O, 4% CO₂ in N₂, the space velocity was kept at 90 k h-1. Under these conditions the test was run for 30 min. After this the temperature was set to rise by 40° C./min until 550° C. was reached (SV=90 k h-1, 225 ppm NH₃, 12% O₂, 4% H₂O, 4% CO₂). During this test, the inlet and outlet concentrations were measured with an FTIR.

The N₂O and NOx emissions are taken from the 10 min heat up period from 150° C.-550° C. and are integrated over this time period and calculated in mg per liter catalyst volume. Therefore, the lower the NH₃ T50 light off temperature the more NH₃ is oxidized. NH₃ T50 is the temperature if 50% of the inlet NH₃ concentration is reached during the heating period.

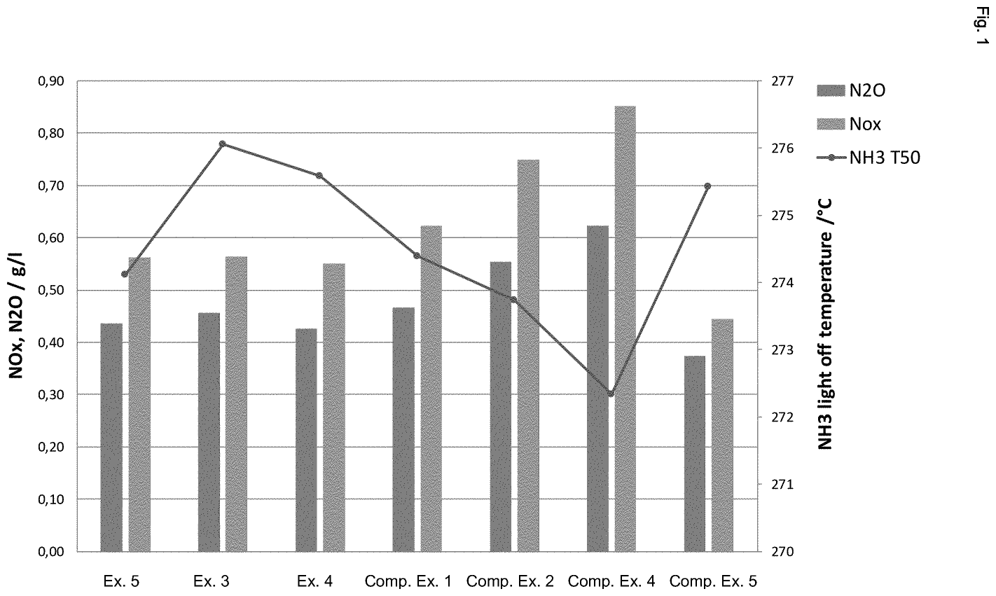

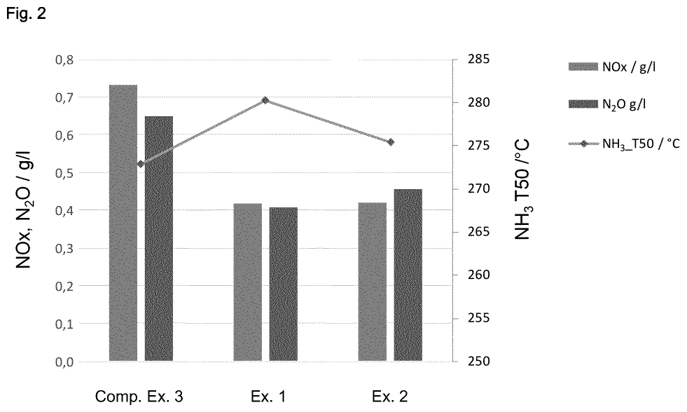

The testing results are shown in FIGS. 1 and 2. Thus, as may be taken from the results from catalyst testing, the best results in the conversion of ammonia to nitrogen gas with low NOx and N₂O make is obtained using a combination of Pr₆O₁₁ and MnO₂ in Examples 1 to 4, followed by Example 5, which employs a combination of MnO₂ and TiO₂. Combinations of MnO₂ and TiO₂ in Comparative Examples 1 and 3, or TiO₂ alone in Comparative Example 2, on the other hand, provided considerably poorer results in NOₓ and N₂O abatement. The worst results were obtained for Comparative Example 4, which contains none of MnO₂, Pr₆O₁₁, and TiO₂.

As may be taken from the results obtained with Comparative Example 5, which not only contains more than the amount of Pt but furthermore contains Rh, these compare well to those obtained with the inventive catalysts. Thus, it has quite surprisingly been found that in an ammonia oxidation catalyst, the specific combination of an oxygen storage component, and in particular Pr₆O₁₁, with a dioxide of Mn and/or Ti may serve as a highly cost-efficient alternative to the use of Rh with considerably higher amounts of Pt.

### CITED PRIOR ART

WO 2015/172000 A1
CN 109590021 A
US 2012/0167553 A1
Jingdi, C. et al. in Chem. J. of Chin. Univ. 2015, Vol. 36, No. 3, pages 523-530
WO 2017/037006 A1
WO 2020/234375 A1
WO 2020/210295 A1

1. A catalyst for the oxidation of ammonia (AMOX catalyst), wherein the catalyst comprises as components:
(a) Pt and/or Pd as one or more platinum group metals, wherein the one or more platinum group metals are supported on a support material;
(b) one or more rare earth metal oxides selected from the group of oxides of Pr, Nd, and Ce, including combinations of two or more thereof;
(c) one or more transition metal oxides selected from the group consisting of oxides of Mn, Ti, V, Nb, and Ta, including combinations of two or more thereof;
(d) one or more zeolitic materials; and
(e) optionally one or more binders;
wherein the one or more zeolitic materials are loaded with Cu and/or Fe.

2. The catalyst of claim 1, wherein the one or more platinum group metals comprise Pt.

3. The catalyst of claim 1, wherein the one or more platinum group metals Pt and/or Pd are contained in the catalyst at a loading comprised in the range of from 0.1 to 30 g/ft³.

4. The catalyst of claim 1, wherein the catalyst comprises 1 wt.-% or less of Rh calculated as the element and based on 100 wt.-% of the total amount of the one or more platinum group metals Pt and/or Pd calculated as the element.

5. The catalyst of claim 1, wherein the catalyst comprises 1 wt.-% or less of Pd calculated as the element and based on 100 wt.-% of the total amount of the one or more platinum group metals Pt and Pd calculated as the element.

6. The catalyst of claim 1, wherein the one or more rare earth metal oxides comprise praseodymium oxide.

7. The catalyst of claim 1, wherein the one or more transition metal oxides in (c) are selected from the group consisting of MnO₂, TiO₂, VO₂, V₂O₅, Nb₂O₅, and Ta₂O₅, including mixtures of two or more thereof.

8. The catalyst of claim 1, wherein the one or more rare earth metal oxides and the one or more transition metal oxides are present as a mixed oxide.

9. The catalyst of claim 1, wherein the one or more transition metal oxides comprise MnO₂ and TiO₂, wherein the one or more transition metal oxides consist of MnO₂ and TiO₂.

10. The catalyst of claim 1, wherein the one or more zeolitic materials have a framework-type structure selected from the group consisting of CHA, AEI, RTH, LEV, DDR, KFI, ERI, and AFX, including combinations or mixed structures of two or more thereof.

11. The catalyst of claim 1, wherein the catalyst further comprises a substrate.

12. An exhaust gas treatment system for the treatment of exhaust gas exiting from an internal combustion engine, the system comprising an AMOX catalyst according to claim 1 and one or more of a diesel oxidation catalyst, a catalyst for the selective catalytic reduction of NOₓ (SCR catalyst), and an optionally catalyzed soot filter.

13. A method for the selective catalytic reduction of NOx, wherein the NOx is comprised in an exhaust gas stream, said method comprising
(A) providing the exhaust gas stream;
(B) passing the exhaust gas stream provided in (A) through an AMOX catalyst according to claim 1 or through an exhaust gas treatment system comprising an AMOX catalyst according to claim 1 and one or more of a diesel oxidation catalyst, a catalyst for the selective catalytic reduction of NOₓ (SCR catalyst), and an optionally catalyzed soot filter.

14. A process for the preparation of a catalyst for the oxidation of ammonia, wherein the process comprises:
(1) providing one or more salts of Pt and/or Pd;
(2) providing one or more support materials;
(3) impregnating the one or more salts of Pt and/or Pd provided in (1) onto the one or more support materials provided in (2);
(4) providing one or more transition metal oxides, and/or one or more precursors thereof, wherein the one or more transition metal oxides are selected from the group consisting of oxides of Mn, Ti, V, Nb, and Ta, including combinations of two or more thereof;
(5) adding the one or more transition metal oxides and/or the one or more precursors thereof provided in (4) to the one or more impregnated support materials obtained in (3) and admixing the resulting mixture;
(6) providing one or more rare earth metal oxides, and/or one or more precursors thereof, selected from the group of oxides of Pr, Nd, and Ce, including combinations of two or more thereof;
(7) adding the one or more rare earth metal oxides and/or the one or more precursors thereof provided in (6) to the mixture obtained in (5) and admixing the resulting mixture;
(8) optionally drying the mixture obtained in (7);
(9) calcining the mixture obtained in (7) or (8);
(10) suspending the calcined mixture obtained in (9) in a solvent system;
(11) optionally milling the suspension obtained in (10);
(12) providing one or more zeolitic materials;
(13) optionally providing one or more binders and/or one or more precursors thereof;
(14) adding the optional one or more binders and/or the one or more precursors thereof provided in (13) to the one or more zeolitic materials provided in (12) and admixing the resulting mixture;
(15) adding the suspension obtained in (10) or (11) to the mixture obtained in (14) and admixing the resulting mixture for obtaining a slurry;
(16) providing a substrate;
(17) coating the slurry obtained in (15) onto the substrate provided in (16) for obtaining a coated substrate;
(18) optionally drying the coated substrate obtained in (17); and
(19) calcining the mixture obtained in (17) or (18);
wherein the one or more zeolitic materials provided in (12) are loaded with Cu and/or Fe.

15. (canceled)
